(19) United States
(12) Patent Application Publication
(10) Pub. No.: US 2010/0072670 A1
(43) Pub. Date: Mar. 25, 2010

(54) PROCESS AND PLANT FOR PRODUCING TYRES FOR VEHICLE WHEELS

(76) Inventors: Fiorenzo Mariani, Milano (IT); Maurizio Marchini, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/448,304

(22) PCT Filed: Dec. 22, 2006
(86) PCT No.: PCT/IB2006/004147

§ 371 Date: Jun. 17, 2009

(51) Int. Cl. B29D 30/10

(52) U.S. Cl. 264/331.11; 425/50

(57) ABSTRACT

A plant and a process for producing tyres for vehicle wheels includes the steps of a) building a tyre on a toroidal support in a building line of a production plant; b) moulding and vulcanizing the assembled tyre in a vulcanization line of the production plant; c) transferring by means of a first transfer device the toroidal support and the relevant moulded and vulcanized tyre to a working station including a removing unit for removing the tyre from the respective toroidal support and a cooling unit for cooling the toroidal support; d) removing the moulded and vulcanized tyre from the relevant toroidal support in the removing unit; e) transferring the toroidal support from the removing unit to the cooling unit by means of a second transfer device different from the first transfer device; and f) cooling the toroidal support in the cooling unit.

The object of the present invention is a process for producing tyres for vehicle wheels.

In particular, the present invention relates to a process for producing tyres built on a toroidal support.

It is also an object of the invention a plant for producing tyres for vehicle wheels, able to be used for carrying out the aforementioned producing process.

Modern production cycles of a tyre provide that, after a building process wherein the various components of the same tyre are made and/or assembled in a building line, a moulding and vulcanization process is carried out, in a suitable vulcanization line, adapted for defining the tyre structure according to a desired geometry and tread pattern.

A tyre generally comprises a toroidally ring-shaped carcass including one or more carcass plies, strengthened with reinforcing cords lying in substantially radial planes (a radial plane contains the rotation axis of the tyre). Each carcass ply has its ends integrally associated with at least one metal reinforcing annular structure, known as bead core, constituting the reinforcing at the beads, i.e. at the radially inner ends of the tyre, having the function of enabling the assembling of the tyre with a corresponding mounting rim. Placed crown wise to said carcass is a band of elastomeric material, called tread band, within which, at the end of the moulding and vulcanization steps, a raised pattern is formed for ground contact. A reinforcing structure, generally known as belt structure, is arranged between the carcass and the tread band. Such structure usually comprises, in the case of car tyres, at least two radially superposed strips of rubberised fabric provided with reinforcing cords, usually of metal material, arranged parallel to each other in each strip and in a crossed relationship with the cords of the adjacent strip, preferably symmetrically arranged with respect to the equatorial plane of the tyre. Preferably, the belt structure further comprises at a radially outer position thereof, at least on the ends of the underlying belt strips, also a third layer of textile or metallic cords, circumferentially disposed (at zero degrees).

Finally, in tyres of the tubeless type, that is devoid of an air tube, a radially inner layer, called liner, is present which has imperviousness features for ensuring the air-tightness of the tyre itself.

To the aims of the present invention and in the following claims, by the term “elastomeric material” it is intended a composition comprising at least one elastomeric polymer and at least one reinforcing filler. Preferably, such composition further comprises additives such as cross-linking and/or plasticizing agents. By virtue of the cross-linking agents, such material may be cross-linked by heating, so as to form the final manufactured article.

In recent times, tyre production processes in which a green tyre is built on a rigid toroidal support have been introduced in the field. Said processes are preferably used for tyres produced starting from a limited number of elementary semifinished products fed onto said toroidal support whose outer profile coincides with that of the radially inner surface of the tyre to be produced. The toroidal support is moved, preferably by means of a robotized system, among a plurality of working stations in each of which a particular building step of the tyre is carried out, through automated sequences. At the end of the building steps, the toroidal support with the green tyre supported thereby is arranged inside a vulcanization mould.

In the present context, by the term “green tyre” it is indicated a tyre obtained by the building process and still to be vulcanized.

An example of the above processes is described in WO 01/32409, in the name of the same Applicant, which illustrates a tyre building line provided with working stations, each arranged to make and assemble at least one structural component of the tyre being processed, wherein at least one series of tyres, comprising at least a first and a second model of tyres that are different from each other, is treated simultaneously, and wherein the transferral of the tyres to the vulcanization line is carried out through robotized arms and according to a transferring rate which is equal to the transferring rate of the tyres to each of said working stations.

On the other hand WO 01/39963, in the name of the same Applicant, illustrates a process for producing tyres that are different from each other, comprising a building unit having a plurality of working stations, each adapted for assembling at least one structural component on at least one type of tyre being processed, a vulcanization unit, and a device for transferring and moving the tyre being processed, operating between the working stations and the vulcanization unit.

Said device for transferring and moving the tyre transfers a green tyre from the building unit to the vulcanization unit; after vulcanization, it picks up a vulcanized and moulded tyre from the vulcanization unit and moves it to the first working station of the building unit, where the tyre is removed from the corresponding toroidal support. The latter is then moved by the same device for transferring and moving the tyre into a temperature stabilizing device. If the tyre to be produced requires a toroidal support of a different type, the same device picks up the suitable toroidal support from a feeding station and introduces it into the temperature stabilizing device.

The Applicant has noted that since the above device for transferring and moving the tyre is arranged for carrying out numerous operations and making wide displacements, it is often the bottleneck of the producing process. For example, making tyres differing from one another as illustrated in WO 01/39963, due to the different cooling times required by the toroidal supports and to the variability of the operating times of the building line, the transfer device may have to carry out repeated transfers of the toroidal support between one temperature stabilizing station and a stand-by position.

Moreover, the processes described above do not allow an optimum distribution of the production times, nor an optimum management of the transfer device since the repeated transfers of the toroidal support by means of said device, from a cooling station to the next cooling station or from a cooling station to a stand-by position, require the use of such device for unduly long times, thus decreasing the flexibility and the production capacity of the production plant.

The Applicant has then noted that the pathway accomplished by the transfer device are excessively long with consequent increase of the complexity of the production plant.

The Applicant has therefore perceived that by decreasing the number of transfers of the toroidal support it is possible to obtain a simpler producing process that allows to increase the productivity of a plant for producing tyres for vehicle wheels built on a toroidal support, as well as the layout simplicity thereof.

The Applicant has therefore found that by integrating the unit for removing the tyre from the toroidal support and the unit for cooling the same toroidal support into a single working station it is possible to decrease the work load of the transfer device obtaining a more flexible and efficient producing process.

In accordance with a first aspect thereof, the invention relates to a process for producing tyres for vehicle wheels comprising the steps of:

a) building a tyre on a toroidal support in a building line of a production plant;
b) moulding and vulcanizing said built tyre in a vulcanization line of said production plant;
c) transferring by a first transfer device the toroidal support and the relevant moulded and vulcanized tyre to a working station comprising a removing unit for removing the tyre from the respective toroidal support and a cooling unit for cooling the toroidal support;
d) removing the moulded and vulcanized tyre from the relevant toroidal support in said removing unit;
e) transferring the toroidal support from said removing unit to said cooling unit by a second transfer device different from said first transfer device;
f) cooling the toroidal support in said cooling unit.

Such process allows to solve the aforementioned problems and to achieve a decrease of the work load of the first transfer device with consequent improvement of the efficiency.

Advantageously, after the step f) of cooling the toroidal support, the process comprises the step g) of transferring the cooled toroidal support outward the working station by means of the first transfer device.

Preferably, the step f) of cooling the toroidal support comprises the sub-steps of:

f1) cooling the toroidal support to a temperature comprised between about 100° C. and about 110° C.;
f2) cooling the toroidal support to a temperature comprised between about 55° C. and about 65° C.;
f3) cooling the toroidal support to a temperature suitable for the tyre building process;

In a preferred embodiment, step f3) provides cooling the toroidal support to a temperature comprised between about 40° C. and about 50° C.

Step f1) is preferably carried out with cooling water, advantageously nebulized and sprayed at the outer surface and at the inner surface of the toroidal support.

Preferably, at least one between steps f2) and f3) is carried out with cooling air, advantageously dispensed at the top surface, at the bottom surface and at the outer surface of the toroidal support.

According to a preferred embodiment, the step e) of cooling the toroidal support in the cooling unit comprises the sequential transfer of the toroidal support in at least three specialised stations differing one from the other.

Said sequential transfer is advantageously accomplished by a third transfer device, different from the first transfer device and from the second transfer device.

Said third transfer device preferably comprises a conveyor belt or a robotized arm.

As an alternative, the sequential transfer of the toroidal support from one specialised station to the next one is carried out by the first transfer device.

Preferably, the above step d) of removing the moulded and vulcanized tyre from the relevant toroidal support comprises the sub-steps of

d0) extracting a support shaft of said toroidal support;
d1) dismounting the toroidal support;
d2) separating the vulcanized tyre from the toroidal support;
d3) remounting the toroidal support;
d4) inserting said support shaft into the remounted toroidal support.

Advantageously, at least one between step d0) and d4) is carried out by means of said second transfer device.

As an alternative, at least one between said steps d1), d2) and d3) is carried out by means of a device for dismounting/remounting the toroidal support.

According to a preferred embodiment, the step g) of transferring the cooled toroidal support outward the working station is followed by a step h) of introducing the toroidal support into the building line for building a further tyre.

In accordance with a second aspect thereof, the invention relates to a plant for producing tyres for vehicle wheels comprising:
a line for building a green tyre on a respective toroidal support;
a line for moulding and vulcanizing the tyre;
at least one working station interposed between said building line and said moulding and vulcanization line;
at least a first transfer device for transferring the moulded and vulcanized tyre and the respective toroidal support into said working station;
wherein said working station comprises:
at least one removing unit for removing the moulded and vulcanized tyre from the respective toroidal support;
at least one cooling unit for cooling the toroidal support; and
at least a second transfer device of the toroidal support different from the first transfer device, for transferring the toroidal support from the tyre removing unit to the toroidal support cooling unit.

Such plant solves the above problems relating to the overload of the transfer device and therefore it is flexible and efficient.

Preferably, the first transfer device is also adapted for transferring the toroidal support outward said working station.

The Applicant has noted that using cooling units provided with specialised stations and with devices for moving the toroidal support from one station to the next one, it is possible to further decrease the work load of the transfer device and at the same time, increase the efficiency of the cooling process and therefore of the whole production process.

The Applicant has further noted that said cooling unit, provided with specialised stations and with advance devices, also allows buffering any anomalies of the production cycle since it also acts as a buffer and consequently, allows eliminating any steps of transfer to stand-by positions.

It is therefore preferable that the cooling unit comprises at least three specialised stations for cooling the toroidal support and it is even more preferable that each of them is adapted for carrying out a function different from the functions carried out by the remaining two.

In a preferred embodiment, said specialised stations comprise devices for dispensing cooling fluids which are movable and adjustable. In this way it is possible to adjust the fluid jets in optimum manner according to the size and geometry of the toroidal supports.

In particular, at least one of the specialised stations comprises at least one dispensing device of cooling water or other fluid. In this way it is possible to use the latent evaporation heat of the fluid for cooling the support.

Advantageously, the first specialised station comprises at least one pair of cooling water dispensing devices which are movable, adjustable and provided with nozzles for nebulizing the water and conveying it at specific areas of the toroidal support.

In particular, said first specialised station comprises a first pair of cooling water dispensers for nebulizing the water and conveying it at the outer surfaces of the toroidal support and a second pair of cooling water dispensers for nebulizing the water and conveying it at the inner surfaces of the toroidal support.

According to a preferred embodiment, said specialised stations comprise at least a second specialised station including at least one device for dispensing cooling air and preferably at least three devices for dispensing cooling air which are movable and adjustable.

In particular, said cooling air dispensing devices comprise at least one top dispensing device, one bottom dispensing device and one side dispensing device for conveying the cooling air respectively on the top, bottom and side surface of the toroidal support.

Advantageously, the cooling unit is provided with at least one device for rotating the toroidal support about the axis thereof. Thanks to such device it is possible to obtain homogeneous temperature conditions on the surfaces of the toroidal support.

Preferably, said cooling unit is provided with a third transfer device for the sequential transfer of the toroidal support from one specialised station to the next one, which is different from the first and from the second transfer device.

Preferably, said third transfer device comprises a conveyor belt which operates with a step-by-step movement.

As an alternative, said third transfer device comprises a robotized arm.

Preferably, the removing unit is provided with a dismounting/remounting device adapted for dismounting the toroidal support and remounting it after the tyre has been removed.

Moreover, the cooling unit is advantageously provided with at least one stand-by position for the toroidal supports which may be used in different process steps.

Preferably, the stand-by positions of the cooling unit are at least two and are respectively arranged at the inlet and at the outlet of the working station.

The tyre production plant may further comprise at least one rail operatively associated with at least one between said first transfer device and said second transfer device, as well as driving devices for moving the first and the second transfer device.

Advantageously, at least one between said first transfer device and said second transfer device comprises a robotized arm.

Further features and advantages of invention will be clear from the following description of some preferred examples of production plants and processes according to the invention, made by way of indicating and non-limiting purpose with reference to the annexed drawings, wherein:

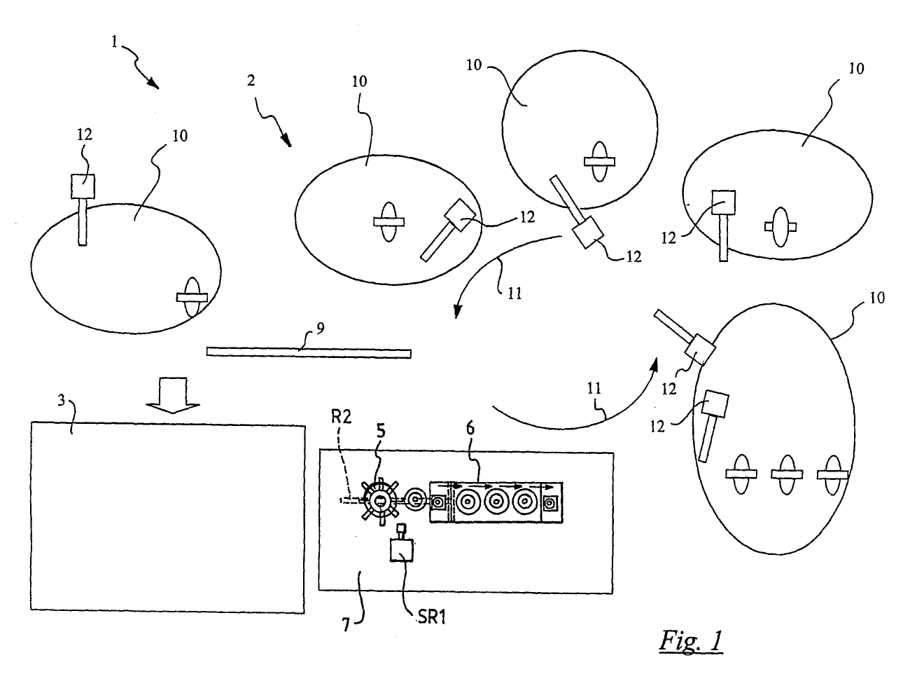

FIG. 1 shows a schematic layout of a plant for producing tyres for vehicle wheels wherein the process according to the present invention is carried out;

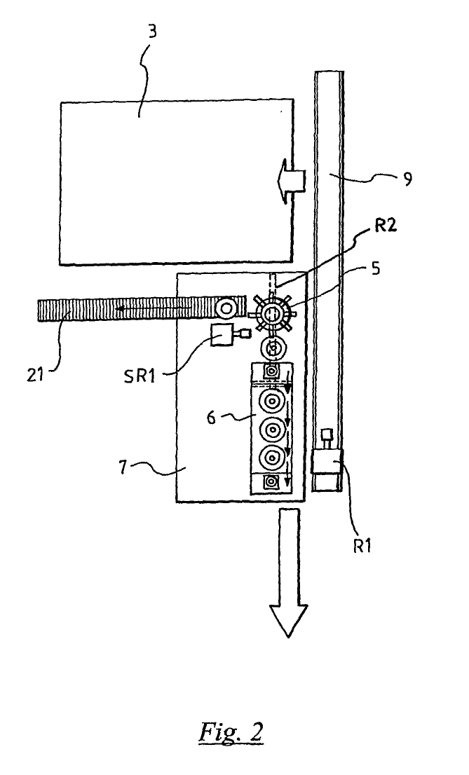

FIG. 2 shows a detail of FIG. 1;

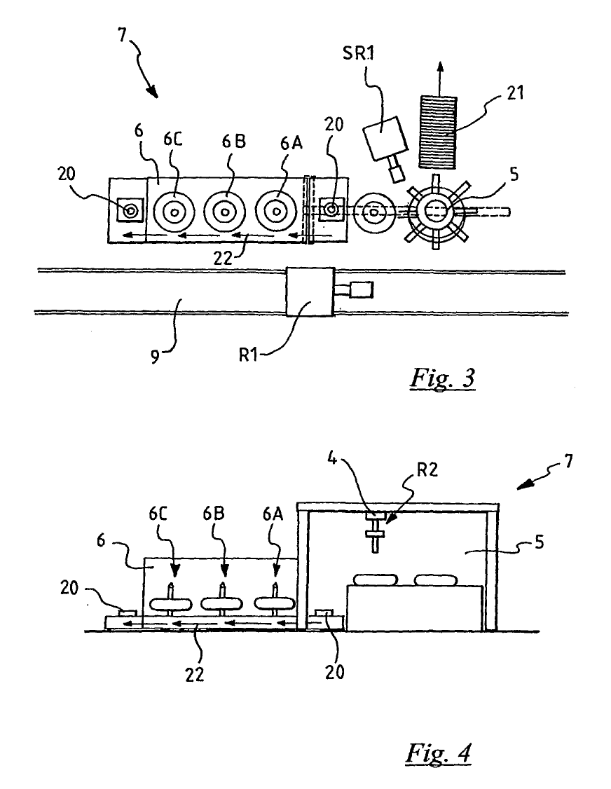

FIG. 3 shows a schematic plan view of a working station, comprising a removing unit and a cooling unit, of a plant for producing tyres for vehicle wheels according to a first embodiment of the invention during a step of the subject process;

FIG. 4 shows a side view of FIG. 3; and

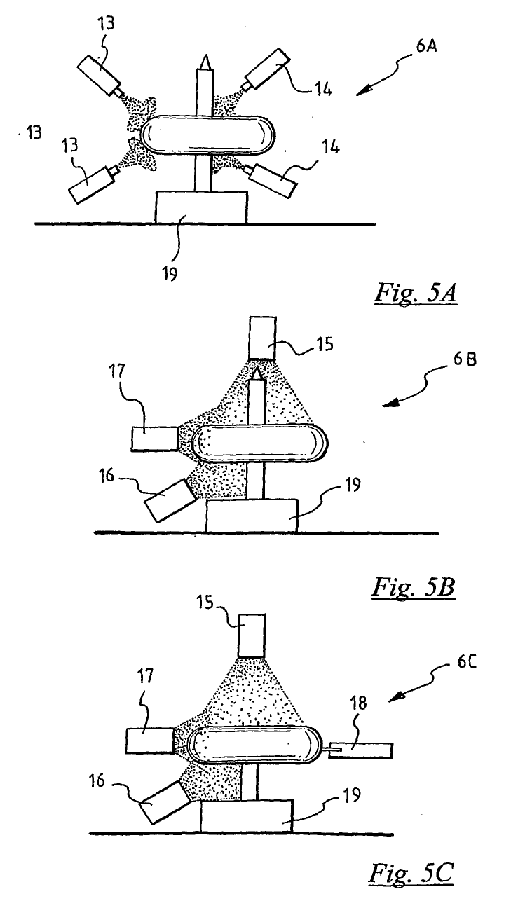

FIGS. 5a, 5b and 5c show schematic side views of the specialised stations of a cooling unit of a working station of a plant for producing tyres for vehicle wheels according to one embodiment of the invention.

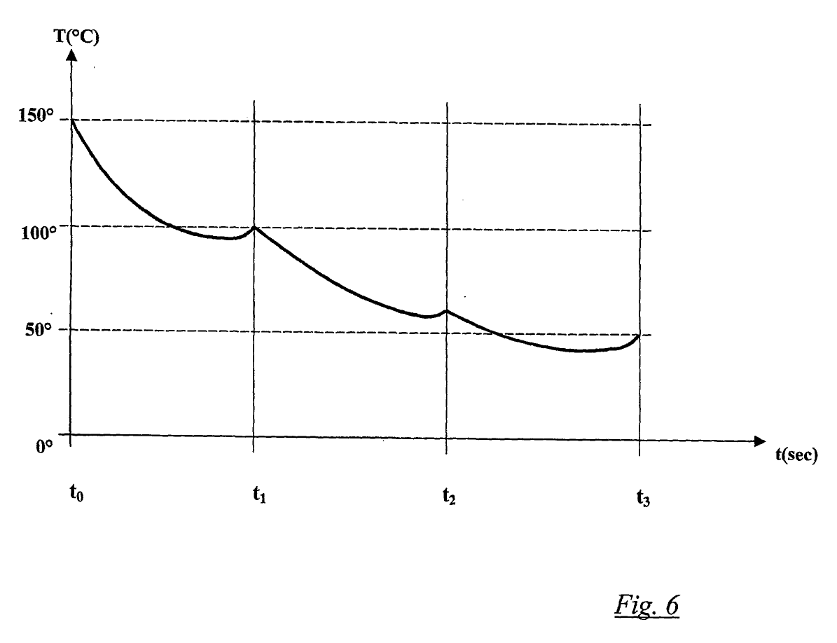

FIG. 6 shows a “time—temperature” diagram relating to the surface of a toroidal support during the cooling step according to one embodiment of the process of the present invention.

With reference to FIG. 1, by reference numeral 1 it is generally indicated a plant for producing tyres for vehicle wheels according to the present invention by which the production process according to the present invention is carried out.

Plant 1 comprises a building line 2, wherein each tyre is built by assembling structural components according to a predetermined sequence, and a moulding and vulcanization line 3, wherein each green tyre is moulded and vulcanized, within a respective vulcanization mould, thus becoming a finished product.

The building line 2 comprises a plurality of building stations 10 preferably arranged along a closed loop path indicatively represented by arrows 11 in FIG. 1.

Preferably, said building stations 10 operate simultaneously with each other, each on at least one tyre for assembling at least one of its structural components thereon.

It should be noted that in the present description and in the subsequent claims, by “structural component” of the tyre it is meant any component selected for example from: liner, sub-liner, carcass ply/plies, sub-belt insert, belt strips either crossing over one another or at zero degrees, attachment sheets for the tread band, tread band, rim, bead filler, textile or metallic reinforcing inserts, anti-abrasion insert, or any portion thereof.

In particular, during the building step the various structural components used for making each tyre are advantageously engaged on a toroidal support whose shape substantially reproduces the internal configuration of the tyre to be obtained. Such a toroidal support has a removable support shaft adapted for retaining the sectors of which the toroidal support is formed of. Such type of toroidal support collapsible or dismountable into a plurality of sectors, so as to be easily removed from the tyre when processing is completed, is for example described in document WO 01/62481 in the name of the Applicant.

Transfer devices 12 operate in the building line 2 for sequentially transferring each of the tyres being processed associated with a respective toroidal support from one of the building stations 10 to the next building station, so as to determine the sequential assembly of all the tyre components.

Preferably, such transfer devices 12 comprise one or more robotized arms associated with at least one of the building stations 10 and operating on the individual toroidal supports for carrying out the sequential transfer of each tyre being processed.

According to the present invention, the production plant 1 further comprises at least one working station 7 interposed between said building line 2 and said moulding and vulcanization line 3 and at least a first transfer device R1 for transferring the moulded and vulcanized tyre and the respective toroidal support inside working station 7.

Said working station 7 comprises:
at least one removing unit 5 for removing the moulded and vulcanized tyre from the respective toroidal support;
at least one cooling unit 6 for cooling the toroidal support; and at least a second transfer device of the toroidal support R2, different from the first transfer device R1, for transferring the toroidal support from the tyre removing unit 5 to the toroidal support cooling unit 6.

In the embodiment shown in FIGS. 1 and 2, the working station 7 comprises a single removing unit 5, a single cooling unit 6 and one second transfer device R2 for transferring the toroidal support from the first to the second of said units.

According to a preferred embodiment, the first transfer device R1 is also adapted for transferring the toroidal support outward the working station 7.

The removing unit 5 is adapted for receiving a vulcanized tyre and the respective toroidal support for carrying out the operation of removing the vulcanized tyre. Within the present scope, by the term “tyre removal” it is meant at least the set of operations for dismounting the toroidal support and for removing the tyre from the above dismounted toroidal support.

According to a preferred embodiment, said second transfer device R2 is obtained by a handling device 4, illustrated in FIG. 4, also adapted for extracting and inserting said support shaft of the toroidal support so as to allow the latter to be respectively disassembled in a plurality of sectors and reassembled in its operating toroidal shape.

According to a further alternative embodiment, the removing unit 5 comprises a device SR1 for dismounting/remounting the toroidal support which allows removing the moulded and vulcanized tyre from the toroidal support and remounting the toroidal support itself after the tyre removal.

With particular reference to FIGS. 3 and 4, it is shown that the cooling unit 6 comprises at least three specialised stations 6A, 6B and 6C, each specialised in carrying out a specific step of the cooling of the toroidal support.

According to a preferred embodiment, each of said specialised stations 6A, 6B, 6C is adapted for performing a function that differs from the functions performed by the remaining two.

FIGS. 5A, 5B and 5C show that said specialised stations 6A, 6B, 6C are provided with special dispensing devices 13, 14, 15, 16, 17 of cooling fluids.

In particular, the cooling unit 6 comprises a first specialised station 6A including at least one dispensing device 13, 14 of cooling water or other service fluids.

In the embodiment shown in FIG. 5A, said first specialised station 6A comprises two pairs of cooling water dispensing devices 13, 14. Such devices 13, 14 are movable, adjustable and provided with nozzles for nebulizing the water and conveying it at specific areas of the toroidal support.

In particular, a first pair of cooling water dispensers 13 conveys the cooling water at the outer surfaces of the toroidal support and a second pair of cooling water dispensers 14 conveys the water at the inner surfaces of the toroidal support.

The cooling unit 6 of the production plant 1 also comprises a second specialised station 6B which includes devices 15, 16, 17 for dispensing cooling air or other service fluids.

In the embodiment shown in FIG. 5B, the second specialised station 6B comprises three cooling air dispensing devices 15, 16, 17: a top dispensing device 15, a bottom dispensing device 16 and a side dispensing device 17 for conveying the cooling air respectively on the top, bottom and side surface of the toroidal support.

Said cooling air dispensing devices 15, 16, 17 are preferably movable and adjustable in a manner similar to the cooling water dispensing devices 13, 14.

The cooling unit 6 is further provided with one or more temperature sensors 18 arranged in one or more of the specialised stations 6A, 6B, 6C, adapted for monitoring the thermal trend of the toroidal supports during the production process according to the present invention.

The cooling unit 6 is further provided with at least one rotation device 19 adapted for rotating the toroidal support about the axis thereof while cooling.

The cooling unit 6 is finally provided with a third transfer device adapted for carrying out the sequential transfer of the toroidal support from one specialised station 6A, 6B, 6C to the next one, which is different from the first transfer device R1 and from the second transfer device R2.

Such third transfer device comprises a conveyor belt preferably operating with a step-by-step movement for transferring the toroidal support at predetermined frequencies from one specialised station 6A, 6B, 6C to the next one. In this way, the cooling unit 6 is a tunnel wherein the toroidal supports run according to a travelling direction indicated by arrows 22 in the figures.

Alternatively, said third transfer device comprises a robotized arm that picks up the toroidal support from one specialised station 6A, 6B, 6C and moves it to the next one.

According to an embodiment of the present invention, the production plant 1 is provided with a transport device 21 adapted for transporting the moulded, vulcanized tyre removed from the relevant toroidal support, outward the working station 7.

The cooling unit 6 may be provided with one or more stand-by positions 20 of the toroidal supports adapted for the temporary storage of the toroidal supports.

Preferably, said stand-by positions 20 are two and are respectively arranged at the inlet and at the outlet of the working station 7.

The production plant 1 further comprises at least one rail operatively associated with the first transfer device R1 and/or to the second transfer device R2.

In the embodiments shown in FIGS. 2 and 3, plant 1 is provided with a pair of rails which make up a track 9 on which the first transfer device R1 travels.

The production plant 1 further comprises driving devices, not shown in the figures, for moving the first transfer device R1 and the second transfer device R2.

At least one between said first transfer device R1 and said second transfer device R2 comprises a robotized arm. In the embodiments shown in the figures, R1 comprises a robotized arm.

The vulcanization line 3 comprises at least one unit for vulcanizing the green tyre provided with six vulcanization moulds.

Preferably, the vulcanization moulds are mounted on a turntable to be driven in rotation so as to make the same vulcanization moulds carry out a closed-loop path, sequentially carrying them, one after the other, to a tyre loading/unloading station, each associated with its own toroidal support.

In this way, a green tyre, after having been loaded into a vulcanization mould, is subjected to a moulding and vulcanization process and, once the suitable time to complete the moulding and vulcanization operations has been achieved, is unloaded from the mould at the same loading/unloading station through rotation of the turntable.

The vulcanization moulds are preferably sealed airtight and are arranged to house a tyre being processed previously built on a toroidal support, the outer surface of which substantially reproduces the internal configuration of the tyre to be obtained. Said vulcanization moulds are provided with working fluid passage devices as illustrated for example in WO 2004/045837, in the name of the same Applicant.

If required by production requirements, it is possible to design the vulcanization line 3 so as to comprise two vulcanization units. In this case it is possible but not necessary to provide two working stations 7 or a single working station 7 provided with two removing units and/or two cooling units 6.

With reference to the production plant 1 illustrated in FIGS. 1-5C, a preferred embodiment of a production process according to the invention shall now be described.

In accordance with a first step a), a green tyre is assembled on a respective toroidal support assembling each structural component of the tyre according to a predetermined sequence at the above building stations 10 of the building line 2 of the production plant 1.

This building step of each tyre is carried out for example according to methods illustrated in document WO 01/32409, in the name of the same Applicant.

At the end of the building step, the tyre production process according to the present invention provides the performance of a step b) of moulding and vulcanizing the green tyre in the vulcanization line 3 of the production plant 1 so as to define the structure of the tyre according to the desired geometry and tread pattern.

Afterwards, the process according to the present invention provides a step c) of transferring the toroidal support and the relevant tyre vulcanized in the aforesaid working station 7 comprising the removing unit 5 of the tyre from the respective toroidal support and the cooling unit 6 for cooling the toroidal support. Said step c) is carried out by the above first transfer device R1.

In the removing unit 5 of the working station 7, the tyre is removed from the relevant toroidal support in a step d) that comprises the dismounting of the toroidal support and the removal of the moulded and vulcanized tyre from said toroidal support; Preferably said step d) also comprises the subsequent remounting of the toroidal support, which is therefore ready for a new production cycle.

At this point, the step e) of transferring the toroidal support from the removing unit 5 into the cooling unit 6 is carried out by a second transfer device R2 different from said first transfer device, said second transfer device R2 preferably comprising said handling device 4.

In accordance with the process according to the present invention, the step f) of cooling the toroidal support is carried out in said cooling unit 6.

Once the toroidal support has been cooled, it is transferred outward the working station 7, in accordance with a step g), preferably by means of the first transfer device R1.

In particular, the step f) of cooling the toroidal support comprises the following steps:

f1) cooling the toroidal support to a temperature comprised between about 100° C. and about 110° C.;
f2) cooling the toroidal support to a temperature comprised between about 55° C. and about 65° C.;
f3) cooling the toroidal support to a temperature suitable for the tyre building process;

In accordance with a preferred embodiment, step f3) comprises cooling the toroidal support to a temperature comprised between about 40° C. and about 50° C.

Preferably, step f1) is carried out by means of cooling water at a temperature comprised between about 10° C. and about 20° C. and one or both steps f2) and f3) are carried out by cooling air at a temperature comprised between about 3° C. and about 10° C.

As shown in FIG. 5A, the cooling water is nebulized and sprayed at the outer surface and at the inner surface of the toroidal support.

On the other hand, FIGS. 5B and 5C show how the cooling air is dispensed at the top surface, the bottom surface and the outer surface of the toroidal support.

The process for producing tyres according to an embodiment of the present invention provides that the step e) of cooling the toroidal support comprises the sequential transfer of the toroidal support in at least three specialised stations 6A, 6B, 6C differing one from the other.

Preferably, said sequential transfer of the toroidal support takes place by a third transfer device different from the first transfer device R1 and from the second transfer device R2, said third transfer device comprising a conveyor belt or a robotized arm.

According to a further alternative embodiment, the sequential transfer of the toroidal support from one specialised station 6A, 6B, 6C to the next one is carried out by the first transfer device R1. In that case, the cooling unit 6 is not configured as a tunnel.

The step d) of removing the moulded and vulcanized tyre from the relevant toroidal support in said removing unit 5 comprises the steps of:

d0) extracting the support shaft of the toroidal support;
d1) dismounting the toroidal support;
d2) separating the vulcanized tyre from the toroidal support;
d3) remounting the toroidal support;
d4) inserting said support shaft into the remounted toroidal support.

Preferably, steps d0) and d4) are carried out by the second transfer device R2 in the embodiment of the handling device 4.

Preferably, steps d1), d2) and d3) are carried out by the above device SR1 for dismounting/remounting the toroidal support.

At least one between step d1) of dismounting the toroidal step and step d2) of remounting of the toroidal support is carried out by the above handling device 4. As an alternative, at least one between said steps d1) and d2) is carried out by the second transfer device R2.

Once the cooled toroidal support has been transferred outward the working station 7 in accordance with step g), it is possible to provide a step h) of introduction of the toroidal support into the building line (2) for building a further tyre.

FIG. 6 shows a diagram of the surface temperature of a toroidal support as a function of the cooling time elapsed according to one embodiment of the process of the present invention.

In such figure, by “t” it is indicated the cooling time—expressed in seconds (sec.)—and by “T” the surface temperature—expressed in ° C.—of a toroidal support subject to the process according to one embodiment of the present invention.

In particular, by “to” it is indicated the start time of the cooling step f) that coincides with the beginning of step f1), “t1” the start time of step f2), “t2” the start time of step f3) and by “t3” the start time of step f3) that coincides with the end of step f).

In a tyre production process for motorcycle wheels, according to one embodiment of the present invention, carried out in a production plant 1, of the type illustrated in FIGS. 1-5C, if t0=0 sec., t1=about 90 sec., t2=about 180 sec. and t3=about 270 sec.

In the scope of the present previous description and the following claims, all the numerical measurements indicating quantity, parameters, percentages, etc, are to be considered as preceded by the term “about”, unless otherwise specified. Furthermore, all the intervals of numerical measurement include all the possible combinations of the maximum and minimum numerical values, as well as all the possible intermediate intervals, as well as those specifically indicated in the text.

1-48. (canceled)

49. A process for producing a tyre for a vehicle wheel comprising the steps of.
a) building a tyre on a toroidal support in a building line of a production plant;
b) moulding and vulcanizing said built tyre in a vulcanization line of said production plant to produce a moulded and vulcanized tyre;
c) transferring by means of a first transfer device the toroidal support and the moulded and vulcanized tyre to a working station comprising a removing unit for removing the tyre from the respective toroidal support and a cooling unit for cooling the toroidal support;
d) removing the moulded and vulcanized tyre from the toroidal support in said removing unit;
e) transferring the toroidal support from said removing unit to said cooling unit by means of a second transfer device different from said first transfer device; and
f) cooling the toroidal support in said cooling unit.

50. The process for producing a tyre for vehicle wheels according to claim 49, comprising, after cooling the toroidal support in step f); g) transferring the cooled toroidal support outward the working station by means of the first transfer device.

51. The process for producing a tyre for a vehicle wheel according to claim 49, wherein step f) of cooling the toroidal support comprises the sub-steps of:
f1) cooling the toroidal support to a temperature of about 100° C. to about 110° C.;
f2) cooling the toroidal support to a temperature of about 55° C. to about 65° C.; and
f3) cooling the toroidal support to a temperature suitable for the tyre building process.

52. The process for producing a tyre for a vehicle wheel according to claim 51, wherein step f3) comprises cooling the toroidal support to a temperature of about 40° C. to about 50° C.

53. The process for producing a tyre for a vehicle wheel according to claim 51, wherein step f1) is carried out by means of cooling water.

54. The process for producing a tyre for a vehicle wheel according to claim 53, wherein the cooling water has a temperature of about 10° C. to about 20° C.

55. The process for producing a tyre for a vehicle wheel according to claim 53, wherein the cooling water is nebulized and sprayed at the outer surface and at the inner surface of the toroidal support.

56. The process for producing a tyre for a vehicle wheel according to claim 53, wherein at least one of steps f2) and f3) is carried out by means of cooling air.

57. The process for producing a tyre for a vehicle wheel according to claim 56, wherein both steps f2) and f3) are carried out by means of cooling air.

58. The process for producing a tyre for a vehicle wheel according to claim 56, wherein the cooling air has a temperature of about 3° C. to about 10° C.

59. The process for producing a tyre for a vehicle wheel according to claim 56, wherein the cooling air is dispensed at a top surface, at a bottom surface and at an outer surface of the toroidal support.

60. The process for producing a tyre for a vehicle wheel according to claim 49, wherein step f) of cooling the toroidal support in said cooling unit comprises sequential transfer of the toroidal support in at least three specialised stations, each station differing from the other stations.

61. The process for producing a tyre for a vehicle wheel according to claim 60, wherein the sequential transfer of the toroidal support from one specialised station to the next is carried out by a third transfer device different from the fast transfer device and from the second transfer device.

62. The process for producing a tyre for a vehicle wheel according to claim 61, wherein said third transfer device comprises a conveyor belt

63. The process for producing a tyre for a vehicle wheel according to claim 61, wherein said third transfer device comprises a robotized arm.

64. The process for producing a tyre for a vehicle wheel according to claim 60, wherein the sequential transfer of the toroidal support from one specialised station to a next specialized station is carried out by the first transfer device.

65. The process for producing a tyre for a vehicle wheel according to claim 49, wherein step d) of removing the moulded and vulcanized tyre from the toroidal support in said removing unit comprises the sub-steps of:
d1) extracting a support shaft of said toroidal support;
d2) dismounting the toroidal support;
d3) separating the vulcanized tyre from the toroidal support;
d4) remounting the toroidal support; and
d5) inserting said support shaft into the remounted toroidal support.

66. The process for producing a tyre for a vehicle wheel according to claim 65, wherein at least one of steps d1) to d5) is carried out by said second transfer device.

67. The process for producing a tyre for a vehicle wheel according to claim 65, wherein at least one of steps d2), d3) and d4) is carried out by a device for dismounting/remounting the toroidal support.

68. The process for producing a tyre for a vehicle wheel according to claim 50, wherein step g) of transferring the cooled toroidal support outward from the working station is followed by step h) of introducing the toroidal support into said building line for building another tyre.

69. A plant for producing tyres for vehicle wheels comprising:
a line for building a green tyre on a respective toroidal support;
a line for moulding and vulcanizing the tyre;
at least one working station interposed between said building line and said moulding and vulcanization line; and
at least a first transfer device for transferring the moulded and vulcanized tyre and a respective toroidal support into said working station, wherein said working station comprises:
at least one removing unit for removing the moulded and vulcanized tyre from the respective toroidal support;
at least one cooling unit for cooling the toroidal support; and
at least a second transfer device of the toroidal support, different from the first transfer device, for transferring the toroidal support from the tyre removing unit to the toroidal support cooling unit.

70. The plant for producing tyres for vehicle wheels according to claim 69, wherein the first transfer device is capable of being adapted for transferring the toroidal support outward said working station.

71. The plant for producing tyres for vehicle wheels according to claim 69, wherein the cooling unit comprises at least three specialised stations for cooling the toroidal support.

72. The plant for producing tyres for vehicle wheels according to claim 71, wherein each of said specialised stations is capable of being adapted for performing a function that differs from functions performed by the other two specialised stations.

73. The plant for producing tyres for vehicle wheels according to claim 71, wherein said specialised stations comprise dispensing devices for dispensing cooling fluids.

74. The plant for producing tyres for vehicle wheels according to claim 71, wherein said specialised stations comprise at least a first specialised station comprising at least one cooling water dispensing device.

75. The plant for producing tyres for vehicle wheels according to claim 74, wherein said first specialised station comprises at least one pair of cooling water dispensing devices which are movable, adjustable and provided with nozzles for nebulizing water and conveying the water at specific areas of the toroidal support.

76. The plant for producing tyres for vehicle wheels according to claim 75, wherein said first specialised station comprises a first pair of cooling water dispensers for nebulizing the water and conveying the water at outer surfaces of the toroidal support and a second pair of cooling water dispensers for nebulizing the water and conveying the water at inner surfaces of the toroidal support.

77. The plant for producing tyres for vehicle wheels according to claim 71, wherein said specialised stations comprise at least a second specialised station comprising at least one cooling air dispensing device.

78. The plant for producing tyres for vehicle wheels according to claim 77, wherein said second specialised station comprises at least three cooling air dispensing devices, which are movable and adjustable.

79. The plant for producing tyres for vehicle wheels according to claim 78, wherein said cooling air dispensing devices comprise at least one top dispensing device, one bottom dispensing device and one side dispensing device for conveying the cooling air respectively on a top, bottom and side surface of the toroidal support.

80. The plant for producing tyres for vehicle wheels according to claim 69, wherein said cooling unit is provided with at least one temperature sensor.

81. The plant for producing tyres for vehicle wheels according to claim 71, wherein each specialised station is provided with a temperature sensor.

82. The plant for producing tyres for vehicle wheels according to claim 69, wherein said cooling unit is provided with at least one device for rotating the toroidal support about an axis thereof.

83. The plant for producing tyres for vehicle wheels according to claim 71, wherein said cooling unit is provided with a third transfer device for the sequential transfer of the toroidal support from one specialised station to a next specialized station, said third device being different from the first transfer device and from the second transfer device.

84. The plant for producing tyres for vehicle wheels according to claim 83, wherein said third transfer device comprises a conveyor belt.

85. The plant for producing tyres for vehicle wheels according to claim 84, wherein said conveyor belt transfers the toroidal support from one specialised station to the next specialized station with a step-by-step movement.

86. The plant for producing tyres for vehicle wheels according to claim 83, wherein said third transfer device comprises a robotized arm.

87. The plant for producing tyres for vehicle wheels according to claim 71, wherein said first transfer device is capable of being adapted for the sequential transfer of the toroidal support from one specialised station of the cooling unit to the next cooling unit.

88. The plant for producing tyres for vehicle wheels according to claim 69, wherein said removing unit is provided with a dismounting/remounting device capable of being adapted for dismounting the toroidal support and remounting the toroidal support after a tyre has been removed.

89. The plant for producing tyres for vehicle wheels according to claim 69, wherein said second transfer device comprises a handling device capable of being adapted for extracting a support shaft from the toroidal support and inserting the support shaft in the toroidal support.

90. The plant for producing tyres for vehicle wheels according to claim 69, wherein said cooling unit further comprises at least one stand-by position for the toroidal supports.

91. The plant for producing tyres for vehicle wheels according to claim 90, comprising at least two stand-by positions respectively arranged at an input and at an output of the working station.

92. The plant for producing tyres for vehicle wheels according to claim 69, further comprising at least one rail operatively associated with at least one of said first transfer device and second transfer device.

93. The plant for producing tyres for vehicle wheels according to claim 69, wherein at least a pair of rails form at least one track upon which the first transfer device moves.

94. The plant for producing tyres for vehicle wheels according to claim 69, further comprising driving devices for moving the first transfer device and the second transfer device.

95. The plant for producing tyres for vehicle wheels according to claim 69, wherein at least one of said first transfer device and said second transfer device comprises a robotized arm.

96. The plant for producing tyres for vehicle wheels according to claim 69, further comprising at least one transport device capable of being adapted for transporting a tyre removed from the toroidal support, outward the working station.
